(19) United States
(12) Patent Application Publication
(10) Pub. No.: US 2007/0099601 A1
(43) Pub. Date: May 3, 2007

(54) Method of varying the behavior of a mobile phone based on unhandled events on the mobile phone

(76) Inventors: Tzung-Shian Yang, I-Lan Hsien (TW); Yi-Lun Gau, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/163,727

(22) Filed: Oct. 28, 2005

(51) Int. Cl. H04M 3/42

(52) U.S. Cl. 455/418

(57) ABSTRACT

A method of changing configurations of a mobile phone based on a status of unhandled events includes generating an unanswered factor to record a number of unhandled events received by the mobile phone; receiving an incoming event on the mobile phone, the incoming event being a received phone call or a received message; updating the unanswered factor in response to receiving the incoming event; and executing a first managing process when the unanswered factor exceeds a predetermined threshold.

### BACKGROUND

The present invention relates to a method of changing the configuration or behavior of a mobile phone in response to receiving unhandled phone calls or messages.

Mobile phones have grown in popularity to the point where most people carry a phone with them almost all the time. However, occasionally people will leave their phone behind for a short time or will switch the phone to a quiet theme so as to not disturb others. The result of this is that some calls are missed. Additionally, a mobile phone user may forget to switch the phone theme back from a silent theme to a normal theme, and may miss more phone calls because the incoming calls are not heard.

### SUMMARY OF THE INVENTION

A method of altering the configurations and the behavior of a mobile phone based on a number of unhandled events received by the mobile phone are provided. An exemplary embodiment of a method of changing configurations of a mobile phone based on a status of unhandled events includes generating an unanswered factor to record a number of unhandled events received by the mobile phone; receiving an incoming event on the mobile phone, the incoming event being a received phone call or a received message; updating the unanswered factor in response to receiving the incoming event; and executing a first managing process when the unanswered factor exceeds a predetermined threshold.

An exemplary embodiment of a mobile phone that changes configurations based on a status of unhandled events comprises a receiver for receiving an incoming event on the mobile phone, the incoming event being a received phone call or a received message; an unanswered factor generator, coupled to the receiver, for generating an unanswered factor to record a number of unhandled events received by the mobile phone, wherein the unanswered factor is updated in response to receiving the incoming event; and a processor, coupled to the unanswered factor generator, for executing a first managing process when the unanswered factor exceeds a predetermined threshold.

### BRIEF DESCRIPTION OF THE DRAWINGS

FIG. 1 is a flowchart illustrating the relationship between an incoming event and the unanswered factor.

FIG. 2 is a flowchart illustrating modifying the behavior of the mobile phone according to the unanswered factor (UF).

FIG. 3 is a block diagram illustrating the mobile phone of the present invention.

### DETAILED DESCRIPTION

Keeping track of the number of unhandled events of a mobile phone, such as missed phone calls, unheard voicemail messages, or unread short messages, enhanced media messages, multimedia messages, and email messages, can provide the flexibility of changing the configuration or the behavior of the mobile phone based on the number and type of unhandled events. For example, if a user previously set his mobile phone to a silent mode or vibrating mode and the user later accidentally misplaced his phone, it would be very difficult for the user to find the phone since there would be no audible feedback for the user when the user dials the mobile phone in order to locate it. To overcome this problem, a volume of the phone ringer can be increased gradually as the number of missed calls and messages received by the mobile phone increases. Other functions of the mobile phone can also be altered such as turning on flashing lights or adjusting the vibration settings of the mobile phone.

Many other possible scenarios for changing the configurations and behavior of the mobile phone based on the number of unhandled events are possible. For instance, if the mobile phone is a camera phone with a picture taking function, the mobile phone can be activated to take a picture. One potential use of this could be for allowing a parent to keep an eye on the children while they are left in the care of another person. The parent can simply leave the mobile phone in the same room as the children and configure the phone to take a photo every time the parent calls the mobile phone. The photo can either be saved on the mobile phone, or can be emailed to the parent.

Other possible scenarios include turning off the mobile phone after a predetermined number of unhandled events have been received. Additionally, the mobile phone can be set up to start a video conference with a predetermined video conferencing device or to make a phone call to another phone according to the number of unhandled events. Another potentially useful function is having the mobile phone send out a message, such as a short message, an enhanced message, a multimedia message, or an email message to a predetermined phone number. The message can contain information specifying the amount of unhandled events received by the mobile phone so that the user can realize that many people have been trying to contact him. For times when the user has misplaced the mobile phone, the messages can also contain location information of the mobile phone provided by the Global Positioning System (GPS) or Assisted Global Positioning System (AGPS).

To conveniently keep track of the number of unhandled events received by the mobile phone, an unanswered factor is calculated. The unanswered factor is calculated by accumulating all of the unanswered phone calls and unread messages to give a total unanswered factor value. The individual phone calls and messages can be added together directly, or weighting values can be assigned based on various conditions for giving more weight to some events than others.

For example, weighting values can be assigned according to whether the person calling or sending a message to the mobile phone is listed in the phone book of the mobile phone or not, or if the number is visible or is hidden (i.e. a private number). The user can also create special groups of people that are given higher weight than others, such as family members, coworkers, friends, etc. Numerous other possibilities exist for assigning weighting values, such as varying the weighting values according to a number of unhandled events that have already been received by the mobile phone which have the same phone number as the phone number corresponding to the incoming event. Finally, all of the weighted values are accumulated to produce the unanswered factor.

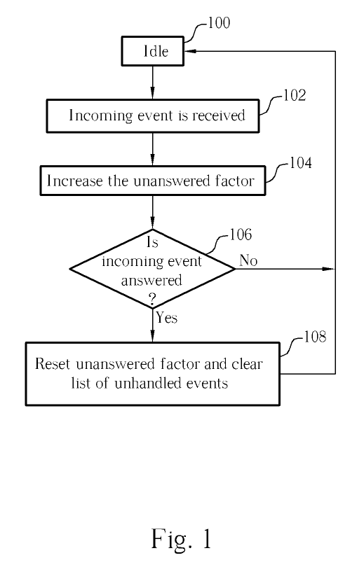

Please refer to FIG. 1. FIG. 1 is a flowchart illustrating the relationship between an incoming event and the unanswered factor. Steps shown in the flowchart are explained below. In step 100, the mobile phone is idle. In step 102, an incoming event is received by the mobile phone, such as an incoming phone call or an incoming message. In response to the incoming event, the unanswered factor is increased in step 104. The incoming event can be assigned a weighting factor depending on the characteristics of the incoming event or depending on if other unhandled events from the same phone number have also been received. In step 106, a determination is made as to whether the incoming event is answered by the user of the mobile phone. If not, then the flow returns to step 100 and the mobile phone remains idle. If the incoming event is answered, the unanswered factor is reset in step 108 and the list of unhandled events is cleared. After the incoming event is handled by the user, the flow returns to step 100 and the mobile phone remains idle.

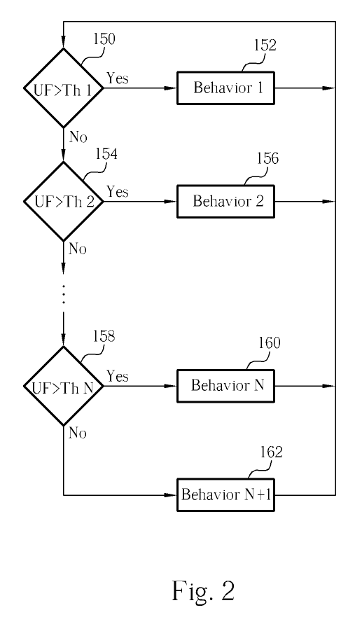

Please refer to FIG. 2. FIG. 2 is a flowchart illustrating modifying the behavior of the mobile phone according to the unanswered factor (UF). Steps shown in the flowchart are explained below. The configuration and the behavior of the mobile phone can be changed constantly, according to the current value of the unanswered factor. The value of the unanswered factor is compared to a first threshold in step 150. If the unanswered factor is greater than the first threshold, the mobile phone is assigned to have a first behavior in step 152. If the unanswered factor is not greater than the first threshold, it is compared to a second threshold in step 154. If the unanswered factor is greater than the second threshold, the mobile phone is assigned to have a second behavior in step 156. This comparison continues by comparing the unanswered factor to up to N different threshold values. If the unanswered factor is not greater than the first N−1 threshold values, it is compared to an Nth threshold in step 158. If the unanswered factor is greater than the Nth threshold, the mobile phone is assigned to have an Nth behavior in step 160. If the unanswered factor is not greater than the Nth threshold, the mobile phone is assigned to have an (N+1)th behavior in step 162. Since the assigned behavior of the mobile phone is constantly changing based on the current value of the unanswered factor, the flow starts with step 150 as soon as a behavior assignment has been made. Please note that in FIG. 2, Threshold 1>Threshold 2> . . . >Threshold N.

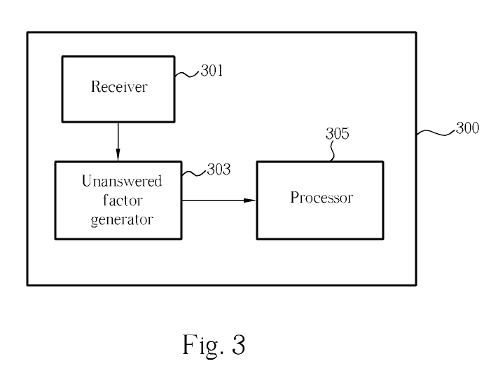

FIG. 3 shows a block diagram illustrating the mobile phone of the present invention. The mobile phone 300 includes a receiver 301, an unanswered factor generator 303, and a processor 305. The receiver 301 receives an incoming event on the mobile phone 300. The incoming event could be a received phone call or a received message. The unanswered factor generator 303, coupled to the receiver 301, generates an unanswered factor to record a number of unhandled events received by the mobile phone 300, wherein the unanswered factor is updated in response to receiving the incoming event. The processor 305, coupled to the unanswered factor generator 303, executes a first managing process when the unanswered factor exceeds a predetermined threshold. Here, the unanswered factor may be reset to a default value in response to the incoming event being answered or handled by users.

In the first managing process, the processor 305 may adjust vibration settings of the mobile phone, adjust volume of the mobile phone, turn on lights of the mobile phone, or even shut down the mobile phone. And, if the mobile phone 300 is equipped with a camera device, the processor 305 may instruct the camera device to take a photo; or if the mobile phone 300 is equipped with a video conferencing device, the processor 305 may initiate a video conference with the video conferencing device. Moreover, in the first managing process, the processor 305 may call a predetermined phone number with the mobile phone or sends a message to a predetermined destination. The message may contain information specifying the current value of the unanswered factor or the current location of the mobile phone.

In some embodiments, the unanswered factor generator 303 may assign a weighting value to individual incoming events and previously unhandled events and accumulates the weighting values to calculate the unanswered factor. The weighting values assigned to individual incoming events may vary according to whether a phone number corresponding to an incoming event is stored in a phone book of the mobile phone, or according to whether a phone number corresponding to an incoming event is visible or is hidden, or according to a number of unhandled events that have already been received by the mobile phone which have the same phone number as the phone number corresponding to the incoming event.

In summary, a variety of factors can be considered when changing the configuration and behavior of a mobile phone, such as the types and quantities of incoming phone calls and messages. The behavior of the mobile phone can be changed in many ways, and can be programmed by the user to do a variety of tasks in response to an increase in the unanswered factor.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of changing configurations of a mobile phone based on a status of unhandled events, the method comprising:
generating an unanswered factor to record a number of unhandled events received by the mobile phone;
receiving an incoming event on the mobile phone, the incoming event being a received phone call or a received message;
updating the unanswered factor in response to receiving the incoming event; and
executing a first managing process when the unanswered factor exceeds a predetermined threshold.

2. The method of claim 1, further comprising resetting the unanswered factor to a default value in response to the incoming event being answered or handled.

3. The method of claim 1, wherein the first managing process comprises adjusting vibration settings of the mobile phone.

4. The method of claim 1, wherein the first managing process comprises adjusting a volume of the mobile phone.

5. The method of claim 1, wherein the first managing process comprises turning on lights of the mobile phone.

6. The method of claim 1, wherein the first managing process comprises taking a photo with a camera function of the mobile phone.

7. The method of claim 1, wherein the first managing process comprises shutting down the mobile phone.

8. The method of claim 1, wherein the first managing process comprises starting a video conference with a predetermined video conferencing device.

9. The method of claim 1, wherein the first managing process comprises calling a predetermined phone number with the mobile phone.

10. The method of claim 1, wherein the first managing process comprises sending a message to a predetermined destination.

11. The method of claim 10, wherein the message contains information specifying the current location of the mobile phone.

12. The method of claim 1, wherein the updating the unanswered factor comprises assigning a weighting value to individual incoming events and previously unhandled events and accumulating the weighting values to calculate the unanswered factor.

13. A mobile phone, changing configurations based on a status of unhandled events, the mobile phone comprising:
a receiver for receiving an incoming event on the mobile phone, the incoming event being a received phone call or a received message;
an unanswered factor generator, coupled to the receiver, for generating an unanswered factor to record a number of unhandled events received by the mobile phone, wherein the unanswered factor is updated in response to receiving the incoming event; and
a processor, coupled to the unanswered factor generator, for executing a first managing process when the unanswered factor exceeds a predetermined threshold.

14. The mobile phone of claim 13, wherein the unanswered factor is reset to a default value in response to the incoming event being answered or handled.

15. The mobile phone of claim 13, wherein in the first managing process, the processor adjusts vibration settings of the mobile phone.

16. The mobile phone of claim 13, wherein in the first managing process, the processor adjusts a volume of the mobile phone.

17. The mobile phone of claim 13, wherein in the first managing process, the processor turns on lights of the mobile phone.

18. The mobile phone of claim 13, wherein the mobile phone is equipped with a camera device, in the first managing process, the processor instructs the camera device to take a photo.

19. The mobile phone of claim 13, wherein in the first managing process, the processor shuts down the mobile phone.

20. The mobile phone of claim 13, wherein the mobile phone is equipped with a video conferencing device, in the first managing process, the processor initiates a video conference with the video conferencing device.

21. The mobile phone of claim 13, wherein in the first managing process, the processor calls a predetermined phone number with the mobile phone.

22. The mobile phone of claim 13, wherein in the first managing process, the processor sends a message to a predetermined destination.

23. The mobile phone of claim 22, wherein the message contains information specifying the current location of the mobile phone.

24. The mobile phone of claim 13, wherein the unanswered factor generator assigns a weighting value to individual incoming events and previously unhandled events and accumulates the weighting values to calculate the unanswered factor.
